(19) United States
(12) Patent Application Publication
(10) Pub. No.: US 2004/0229766 A1
(43) Pub. Date: Nov. 18, 2004

(54) Protomicroemulsion, cleaning implement containing same, and method of use therefor

(75) Inventors: Howard David Hutton III, Oregonia, OH (US); Peter Robert Foley, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/788,121

(22) Filed: Feb. 26, 2004

Related U.S. Application Data
(60) Provisional application No. 60/539,854, filed on Jan. 28, 2004.
(60) Provisional application No. 60/539,855, filed on Jan. 28, 2004.
(60) Provisional application No. 60/535,912, filed on Jan. 12, 2004.
(60) Provisional application No. 60/535,916, filed on Jan. 12, 2004.
(60) Provisional application No. 60/472,941, filed on May 23, 2003.
(60) Provisional application No. 60/451,064, filed on Feb. 28, 2003.

(51) Int. Cl. B08B 3/00; C11D 17/00

(52) U.S. Cl. 510/417; 134/26

(57) ABSTRACT

An ionic surfactant-based protomicroemulsion or microemulsion composition contains, by weight, at least about 20% of an ionic surfactant system, from about 0.1% to about 50% of a low water-soluble compound, and from about 5% to about 79% of a solvent, and is substantially free of low water-soluble oils. The protomicroemulsion forms a microemulsion when diluted from about 10% to about 99% with water.

### CROSS REFERENCES TO RELATED APPLICATIONS

This application claims the benefit of the filing date of U.S. Patent Application No. 60/539,854 and U.S. Patent Application No. 60/539,855, filed Jan. 28, 2004, which claim the benefit of the filing date of U.S. Patent Application No. 60/535,912 and U.S. Patent Application No. 60/535,916, filed Jan. 12, 2004, which claims the benefit of the filing date of U.S. Patent Application No. 60/472,941, filed May 23, 2003, which claims the benefit of the filing date of U.S. Patent Application No. 60/451,064, filed Feb. 28, 2003, which are incorporated by reference herein.

### FIELD OF THE INVENTION

The present invention relates to compositions which form microemulsions when diluted with water. Specifically, the present invention relates to compositions which form microemulsions when diluted with water.

### BACKGROUND OF THE INVENTION

A microemulsion (ME) is a thermodynamically stable, typically clear micellular composition composed of oil, water, and surfactant, formed of dispersed phase droplets having a typical diameter of less than 150 nm. Such MEs have been thought of as oil-in-water, water-in-oil, or middle-phase MEs, and are well known in the art. In addition, compositions which form MEs when diluted with water are also known. Such “protomicroemulsions” (PMEs) and more particularly PMEs which form oil-in-water MEs, typically contain high levels of nonionic surfactants and often salt, to drive the formation of a stable ME when the PME is diluted with water. Such MEs typically fail to provide an acceptable sudsing profile for use as a consumer cleaning product.

However, the art teaches that all MEs and PMEs require the addition of water-insoluble oils to form the ME, either as an added oil, or as a component in a perfume. Specifically, the art teaches that such a low water-soluble oil is necessary for formation of the microemulsion. More specifically the oil is needed in order to form the small oil domains in the oil-in-water microemulsion structure. However, such a low water-soluble oil may be very expensive, and may not serve a purpose in enhancing the cleaning, itself. Further, typical low water soluble oils are often harsh to skin and have strong odors which are unacceptable in many circumstances and products. Many are also extremely volatile, and are therefore preferably avoided or their use minimized. Accordingly, the need exists for a PME composition which is devoid of a water-insoluble oil.

### SUMMARY OF THE INVENTION

The present invention relates to an ionic surfactant-based protomicroemulsion composition, especially a protomicroemulsion for in-home consumer dishwashing use, containing, by weight of the protomicroemulsion, at least about 20% of an ionic surfactant system, from about 0.1% to about 50% of a low water-soluble compound, and from about 5% to about 79% of a solvent. The protomicroemulsion forms a microemulsion when diluted from about 10% to about 99% with water, and is substantially free of water-insoluble oils.

The present invention also relates to an ionic surfactant-based microemulsion composition, especially a microemulsion for in-home consumer dishwashing use, containing, by weight of the protomicroemulsion, at least about 20% of an ionic surfactant system, from about 0.1% to about 50% of a low water-soluble compound, and from about 5% to about 79% of a solvent. The microemulsion is substantially free of water-insoluble oils. It has now been found that a microemulsion and/or a protomicroemulsion can be formed without the use of water-insoluble oils, and that a microemulsion and/or a protomicroemulsion formed with low water-soluble compound instead of a water-insoluble oil has specific performance advantages in terms of speed of grease cleaning, and/or aesthetic characteristics.

All documents cited are, in relevant part, incorporated herein by reference; the citation of any document is not to be construed as an admission that it is prior art with respect to the present invention.

### DETAILED DESCRIPTION OF THE INVENTION

All percentages, ratios and proportions herein are by weight of the protomicroemulsion, unless otherwise specified. All temperatures are in degrees Celsius (° C.) unless otherwise specified.

As used herein, the term “alkyl” means a hydrocarbyl moiety which is straight or branched, saturated or unsaturated. Unless otherwise specified, alkyl moieties are preferably saturated or unsaturated with double bonds, preferably with one or two double bonds. Included in the term “alkyl” is the alkyl portion of acyl groups. As used herein, the term “comprising” means that other steps, ingredients, elements, etc. which do not affect the end result can be added. This term encompasses the terms “consisting of” and “consisting essentially of”.

As used herein, the term “ionic surfactant-based” indicates that a majority of the surfactants present is/are ionic surfactant(s), rather than a nonionic surfactant.

As used herein, the term “low water-soluble compound” means an compound which has a solubility in water of from about 5% to about 0.1% (50,000 ppm to 1000 ppm) by weight of the solution, at 25° C.

As used herein, the term “low water-soluble oil” means an oil which has a solubility in water of from about 5% to about 0.1% (50,000 ppm to 1000 ppm) by weight of the solution, at 25° C.

As used herein, the term “microemulsion” means an oil-in-water emulsion which has the ability to emulsify oil into non-visible droplets, at 25° C. Such non-visible droplets typically have maximum diameter of less than about 100 angstroms (Å), preferably less than 50 Å as measured by methods known in the art, such as ISO 7027 which measures turbidity at a wavelength of 880 nm. Turbidity measuring equipment is easily available from, for example, Omega Engineering, Inc., Stamford, Conn., U.S.A.

As used herein, the term “substantially free of” indicates that while a small amount may be present, as, for example, contaminants, its presence or lack thereof does not significantly affect the technical benefit of the composition.

As used herein, the term “water-insoluble oil” means an oil with a solubility in water of less than 0.1% (1000 ppm) by weight of the solution, at 25° C.

The protomicroemulsion (PME) herein may be diluted with water to form a microemulsion (ME). The PME is an ionic surfactant-based PME comprising at least about 20%, preferably from about 20% to about 80%, more preferably from about 25% to about 40%, of an ionic surfactant system. While many nonionic surfactant-based PMEs are known, it is believed that the ionic surfactant-based PME herein provides many advantages over the nonionic surfactant-based PMEs. For example, the PMEs herein may possess improved sudsing, better rinsing, more acceptable aesthetics, faster oil/grease absorption, and/or may be able to absorb more oil/grease than previous nonionic surfactant-based PMEs. Such improvements are especially desirable for PMEs designed for in-home consumer use. Thus, the present PME is typically intended as a hard surface cleaning composition, a hand or automatic machine dishwashing composition, a scouring composition, and/or a laundry and fabric care composition, preferably a hard surface cleaning composition, a hand dishwashing composition, and/or a scouring composition, more preferably a hard surface cleaning composition and/or a hand dishwashing composition, and even more preferably a hand dishwashing composition. Microemulsions having these characteristics are also specifically contemplated, herein.

The ionic surfactants useful in the ionic surfactant system herein include anionic surfactants, amphoteric surfactants, and zwitterionic surfactants. While cationic surfactants may be present in some cases, the preferred compositions herein are substantially free of cationic surfactants. While such ionic surfactants are typically more challenging to formulate into a PME and a ME due to the salt and pH effects, it is believed that the inherent advantages of an ionic surfactant-based PME system outweigh the difficulties involved, as compared to nonionic surfactant-based systems.

The anionic surfactant useful herein includes water-soluble salts or acids of the formula ROSO₃M, wherein R preferably is a C₆-C₂₀ linear or branched hydrocarbyl, preferably an alkyl or hydroxyalkyl having a C₁₀-C₂₀ alkyl component, more preferably a C₁₀-C₁₄ alkyl or hydroxyalkyl, and M is H or a cation, e.g., an alkali metal cation or ammonium or substituted ammonium, but preferably sodium and/or potassium.

Other suitable anionic surfactants for use herein are water-soluble salts or acids of the formula RO(A)ₘSO₃M wherein R is an unsubstituted linear or branched C₆-C₂₀ alkyl or hydroxyalkyl group having a C₁₀-C₂₀ alkyl component, preferably a C₁₂-C₂₀ alkyl or hydroxyalkyl, more preferably C₁₂-C₁₄ alkyl or hydroxyalkyl, A is an ethoxy or propoxy unit, m is greater than zero, typically between about 0.5 and about 5, more preferably between about 0.5 and about 2, and M is H or a cation which can be, for example, a metal cation, ammonium or substituted-ammonium cation. Alkyl ethoxylated sulfates (abbreviated herein as C_{X-Y}EₘS, where X-Y represents the alkyl group chain length, and where m is the same as described above) as well as alkyl propoxylated sulfates are thus preferred herein. Exemplary surfactants are C₁₀-C₁₄ alkyl polyethoxylate (1.0) sulfate, C₁₀-C₁₄ polyethoxylate (1.0) sulfate, C₁₀-C₁₄ alkyl polyethoxylate (2.25) sulfate, C₁₀-C₁₄ polyethoxylate (2.25) sulfate, C₁₀-C₁₄ alkyl polyethoxylate (3.0) sulfate, C₁₀-C₁₄ polyethoxylate (3.0) sulfate, and C₁₀-C₁₄ alkyl polyethoxylate (4.0) sulfate, C₁₀-C₁₈ polyethoxylate (4.0) sulfate. In a preferred embodiment the anionic surfactant is a mixture of alkoxylated, preferably ethoxylated and non-alkoxylated sulfate surfactants. In such a preferred embodiment the preferred average degree of alkoxylation is from about 0.4 to about 0.8.

Other particularly suitable anionic surfactants for use herein are alkyl sulphonates and alkyl aryl sulphonates, including water-soluble salts or acids of the formula RSO₃M wherein R is a C₆-C₂₀ linear or branched, saturated or unsaturated alkyl or aryl group, preferably a C₁₀-C₂₀ alkyl or aryl group and more preferably a C₁₀-C₁₄ alkyl or aryl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like). Also highly preferred are the linear and branched alkyl benzene sulphonates and more preferably linear alkyl benzene sulphonate.

In a further preferred embodiment, the carbon chain of the anionic surfactant comprises one or more alkyl, preferably C₁₄ alkyl, branching units. In such a case, the average percentage branching of the anionic surfactant is greater than about 30%, more preferably from about 35% to about 80% and most preferably from about 40% to about 60%, by weight of the anionic surfactant. Such average percentage of branching can be achieved by formulating the PME with one or more anionic surfactants all of which are preferably greater than about 30% branched, more preferably from about 35% to about 80% and most preferably from about 40% to about 60%. Alternatively and more preferably, the PME may comprise a combination of branched anionic surfactant and linear anionic surfactants such that on average the percentage of branching of the total anionic surfactant combination is greater than about 30%, more preferably from about 35% to about 80% and most preferably from about 40% to about 60%.

The amphoteric surfactant herein is a surfactant whose charge changes according to the pH of the PME, if applicable, or the ME, and is preferably selected from the various amine oxide surfactants. Amine oxides are semi-polar surfactants and include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

Preferred are amine oxides of the formula:

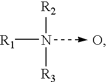

where R₁ is a C₁₀₋₁₄ alkyl and R₂ and R₃ are methyl or ethyl, and those described in U.S. Pat. No. 4,316,824 to Pancheri, granted on Feb. 23, 1982; U.S. Pat. No. 5,075,501 to Borland and Smith, granted on Dec. 24, 1991; and U.S. Pat. No. 5,071,594 to Borland and Smith, granted on Dec. 10, 1991.

Preferred amine oxide surfactants have the formula:

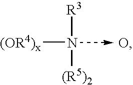

where R³ is an alkyl, a hydroxyalkyl, an alkyl phenyl group or a mixture thereof containing from about 8 to about 22 carbon atoms; R⁴ is an alkylene or hydroxyalkylene group containing from about 2 to about 3 carbon atoms or mixtures thereof; x is from 0 to about 3; and each R⁵ is an alkyl or a hydroxyalkyl group containing from about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure. Preferred amine oxide surfactants include the C₁₀-C₁₈ alkyl dimethyl amine oxides and the C₈-C₁₂ alkoxy ethyl dihydroxy ethyl amine oxides.

Also suitable are amine oxides such as propyl amine oxides, represented by the formula:

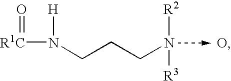

where R¹ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms, R² and R³ are each methyl, ethyl, propyl, isopropyl, 2-hydroxyethyl, 2-hydroxypropyl, or 3-hydroxypropyl and n is from 0 to about 10.

A further suitable species of amine oxide semi-polar surface active agents comprise compounds and mixtures of compounds having the formula:

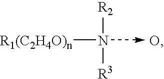

where R₁ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms, R₂ and R₃ are each methyl, ethyl, propyl, isopropyl, 2-hydroxyethyl, 2-hydroxypropyl, or 3-hydroxypropyl and n is from 0 to about 10.

Other suitable, non-limiting examples of the amphoteric surfactant useful in the present invention includes amido propyl betaines and derivatives of aliphatic or heterocyclic secondary and ternary amines in which the aliphatic moiety can be straight chain, or branched and wherein one of the aliphatic substituents contains from about 8 to about 24 carbon atoms and at least one aliphatic substituent contains an anionic water-solubilizing group.

Further examples of suitable amphoteric surfactants are disclosed in “Surface Active Agents and Detergents” (Vol. I and II by Schwartz, Perry and Berch).

Cationic surfactants useful herein include quaternary ammonium salts having at least one C₁₀-C₁₄ alkyl chain, charge-balanced with an anion, such as chloride. Preferred cationic surfactants include the ammonium surfactants such as alkyldimethylammonium halogenides, and those surfactants having the formula:

[R²(OR³)_{y}][R⁴(OR³)_{y}]₂R⁵N⁺X⁻

wherein R² is an alkyl or alkyl benzyl group having from about 8 to about 18 carbon atoms in the alkyl chain, each R³ is selected from the group consisting of —CH₂CH₂—, —CH₂CH(CH₃)—, —CH₃CH(CH₂OH)—, —CH₂CH₂CH₂—, and mixtures thereof; each R⁴ is selected from the group consisting of C₁-C₄ alkyl, C₁-C₄ hydroxyalkyl, benzyl, ring structures formed by joining the two R⁴ groups, —CH₂CHOHCHOHCOR⁶CHOH—CH₂OH wherein R⁶ is any hexose or hexose polymer having a molecular weight less than about 1000, and hydrogen when y is not 0; R⁵ is the same as R⁴ or is an alkyl chain wherein the total number of carbon atoms of R² plus R⁵ is not more than about 18; each y is from 0 to about 10 and the sum of the y values is from 0 to about 15; and X is any compatible anion.

Other cationic surfactants useful herein are also described in U.S. Pat. No. 4,228,044, Cambre, issued Oct. 14, 1980, Mono-alkoxylated and di-alkoxylated ammonium salts may also be used herein, and are commonly available from suppliers such as Clariant Corporation, Charlotte N.C., USA and Akzo Nobel nv, Arnhem, the Netherlands.

Zwitterionic surfactants may also be useful herein and can be broadly described as derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 Laughlin, et al., issued Dec. 30, 1975 at column 19, line 38 through column 22, line 48 for examples of zwitterionic surfactants. Zwitterionic surfactants particularly useful herein include commonly-available betaine surfactants, particularly lauryl amido propyl betaine, C₁₂-C₁₆ cocoamido propyl betaine, and a mixture thereof.

The PME herein also contains less than about 10%, preferably from about 0% to about 10%, more preferably from about 0% to about 5%, and even more preferably from about 0% to about 3% nonionic surfactant. Nonionic surfactants useful herein are generally disclosed in U.S. Pat. No. 3,929,678 to Laughlin, et al., issued Dec. 30, 1975, at column 13, line 14 through column 16, line 6. Other nonionic surfactants useful herein include the condensation products of aliphatic alcohols with from about 1 to about 25 moles of ethylene oxide. The alkyl chain of the aliphatic alcohol can either be straight or branched, primary or secondary, and generally contains from about 8 to about 22 carbon atoms. Particularly preferred are the condensation products of alcohols having an alkyl group containing from about 10 to about 20 carbon atoms with from about 2 to about 18 moles of ethylene oxide per mole of alcohol. Examples of commercially available nonionic surfactants of this type include TERGITOL® 15-S-9 (the condensation product of C_{11-C}₁₅ linear secondary alcohol with 9 moles ethylene oxide), TERGITOL® 24-L-6 NMW (the condensation product of C₁₂-C₁₄ primary alcohol with 6 moles ethylene oxide with a narrow molecular weight distribution), both marketed by Union Carbide Corporation; NEODOL® 45-9 (the condensation product of C₁₄-C₁₅ linear alcohol with 9 moles of ethylene oxide), NEODOL® 23-6.5 (the condensation product of C₁₂-C₁₃ linear alcohol with 6.5 moles of ethylene oxide), marketed by Shell Chemical Company, and KYRO® EOB (the condensation product of C₁₃-C₁₅ alcohol with 9 moles ethylene oxide), marketed by The Procter & Gamble Company, Cincinnati, Ohio, U.S.A. Other commercially available nonionic surfactants include DOBANOL 91-8® marketed by Shell Chemical Co. and GENAPOL UD-080® marketed by Hoechst. This category of nonionic surfactant is referred to generally as “alkyl ethoxylates.”

Also useful herein is a nonionic surfactant selected from the group consisting of an alkyl polyglycoside surfactant, a fatty acid amide surfactant, a C₈-C₂₀ ammonia amide, a monoethanolamide, a diethanolamide, an isopropanolamide, and a mixture thereof. Such nonionic surfactants are known in the art, and are commercially-available. A particularly preferred nonionic surfactant useful herein is a C₉-C₁₂ alkyl polyglycoside from Cognis Corp. USA, Cincinnati, Ohio. Preferred alkylpolyglycosides have the formula:

R²O(CₙH₂ₙO)ₜ(glycosyl)ₓ,

wherein R² is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n is 2 or 3, preferably 2; t is from 0 to 10, preferably 0; and x is from 1.3 to 10, preferably from 1.3 to 3, most preferably from 1.3 to 2.7. The glycosyl is preferably derived from glucose. To prepare these compounds, the alcohol or alkylpolyethoxy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantly the 2-position.

Fatty acid amide surfactants include those having the formula:

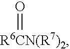

wherein R⁶ is an alkyl group containing from about 7 to about 21 (preferably from about 9 to about 17) carbon atoms and each R⁷ is selected from the group consisting of hydrogen, C₁-C₄ alkyl, C₁-C₄ hydroxyalkyl, and —(C₂H₄O)ₙH where x varies from about 1 to about 3. Preferred amides are C₈-C₂₀ ammonia amides, monoethanolamides, diethanolamides, and isopropanolamides.

The composition herein may comprise up to about 20%, preferably from about 2% to about 10%, of a polyhydroxy fatty acid amide surfactant. If present, the polyhydroxy fatty acid amide surfactant component is typically of the formula:

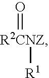

wherein R¹ is H, C₁-C₄ hydrocarbyl, 2-hydroxy ethyl, 2-hydroxy propyl, or a mixture thereof, preferably C₁-C₄ alkyl, more preferably C₁ or C₂ alkyl, even more preferably C₁ alkyl (i.e., methyl); and R² is a C₅-C₃₁ hydrocarbyl, preferably straight chain C₇-C₁₉ alkyl or alkenyl, more preferably straight chain C₉-C₁₇ alkyl or alkenyl, even more preferably straight chain C₁₁-C₁₅ alkyl or alkenyl, or a mixture thereof; and Z is a polyhydroxyhydrocarbyl having a linear hydrocarbyl chain with at least 3 hydroxyls directly connected to the chain, or an alkoxylated derivative (preferably ethoxylated or propoxylated) thereof. R²—C(O)—N< is preferably selected from cocamide, stearamide, oleamide, lauramide, myristamide, capricamide, palmitamide, tallowamide, and a mixture thereof. Z preferably will be derived from a reducing sugar in a reductive amination reaction; more preferably Z will be a glycityl. Suitable reducing sugars include glucose, fructose, maltose, lactose, galactose, mannose, and xylose. As raw materials, high dextrose corn syrup, high fructose corn syrup, and high maltose corn syrup can be utilized as well as the individual sugars listed above. These corn syrups may yield a mix of sugar components for Z. It should be understood that it is by no means intended to exclude other suitable raw materials. Z preferably will be selected from the group consisting of —CH₂—(CHOH)ₙ—CH₂OH, —CH(CH₂OH)—(CHOH)ₙ₋₁—CH₂OH, —CH₂—(CHOH)₂(CHOR)(CHOH)—CH₂OH, and alkoxylated derivatives thereof, where n is an integer from 3 to 5, inclusive, and R is H or a cyclic or aliphatic monosaccharide. Even more preferred are glycityls wherein n is 4, particularly —CH₂—(CHOH)₄—CH₂OH.

The low water-soluble compound is typically present at a level of from about 0.1% to about 50%, preferably from about 0.3% to about 40%, and more preferably from about 0.4% to about 35%, and even more preferably from about 0.5% to about 10%, by weight of the composition. The low water-soluble compound herein has a solubility in water of from about 5% to about 0.1% (50,000 ppm to 1000 ppm) by weight of the solution. Without intending to be limited by theory, it is believed that the low water-soluble compounds herein surprisingly form the microemulsion's micelles, in place of the water-insoluble oils found in typical microemulsions. Furthermore, the incorporation of these low water-soluble compounds provide significant kinetic advantages when parameters such as speed of oil absorption are considered. In a particularly preferred embodiment, the low water-soluble compound is selected from the group consisting of a carbitol, C₁₂₀ glycol, an ether, and a glycol ether including aryl, alkyl, branched, non-branched variants thereof, and a mixture thereof, preferably a carbitol, C₂₆ alkyl glycol ether, aryl C₂₆ alkyl glycol ether, and a mixture thereof having the solubility described above, more preferably phenyl ethylene glycol ether, phenyl propylene glycol ether, and a mixture thereof. Without intending to be limited by theory, it is believed that these low water-soluble compounds are especially beneficial from an odor standpoint, in that they either do not possess strong odors themselves, and/or may be easily blended with other perfumes to provide an acceptable, if not superior odor profile.

The solvent useful herein is selected from the group consisting of water, an alcohol, a glycol, an ether alcohol, and a mixture thereof, more preferably the group consisting of water, a glycol, ethanol, and a mixture thereof, even more preferably the group consisting of propylene carbonate, propylene glycol, water, and a mixture thereof. Accordingly, the solvent herein preferably has a solubility in water of at least about 12%, more preferably of at least about 50%, by weight of the solution. The solvent is typically present at a level of from about 5% to about 79%, preferably from about 7% to about 70%, and more preferably from about 10% to about 50% by weight of the composition.

In a preferred embodiment, a thickener known in the art is also present, preferably selected from a xanthan gum, laponite, a fumed silica, a polyvinyl alcohol, a polyacrylic acid, a polyvinyl pyrrolidone, a cellulose, a modified cellulose, a guar gum, a gum arabic and a mixture thereof, preferably a xanthan gum with a molecular weight of approximately 106. Derivatives of xanthan gum can be used provided they retain the anionic side chains and, preferably, hydroxyl groups. If present, a thickener is typically present at from about 0.1% to about 5%, by weight to adjust the composition to the desired viscosity. Thickeners useful herein are found in, for example, U.S. Pat. No. 4,648,987 to Smith and Munk, issued on Mar. 10, 1987; and U.S. Pat. No. 5,106,609 to Bolich, et al., issued on May 12, 1992. Other thickeners useful herein include those described as “water-soluble thickening polymers” in U.S. patent application Ser. No. 10/705,567, filed on Nov. 10, 2003, to Castro, et al. (P&G Ref. No CM2691M).

In a preferred embodiment, a thickener may be a water transfer agent capable of withdrawing water from the surfactant is also present, especially when the PME is included in a cleaning implement. By “capable of withdrawing water from the surfactant” it is meant that there is a greater affinity between water and the water-transfer agent than there is between water and the surfactant. A water transfer agent acts as a conduit for the evaporation of water from the composition and can increase the rate of water loss from the composition. Useful water transfer agents herein are selected from the group consisting of inorganic oxides and salts, especially hydratable oxides and salts, in particular oxides and salts of silicon, aluminum, zinc, boron, phosphorus, alkaline earth metals and alkali metals and mixtures thereof. Examples include silicates, silicic acid and silica, citric acid, citrates, sodium and potassium tripolyphosphates, sodium and potassium sulfates, magnesium and calcium sulfates. Preferably, the water transfer agent is selected from the group consisting of silica, salts of magnesium and mixtures thereof. More preferably the water transfer agent is silica, preferably amorphous fumed silica. Preferably the water transfer agent has surface area measured by BET (see DIN 66131; originally described in JACS, Vol. 60, 1938, p. 309 by Brunauer, et al.) of from about 5 to about 800 m²/g, more preferably from about 100 to about 400 m²/g.

In a preferred embodiment, an enzyme is also present. The enzyme useful herein includes a cellulase, a hemicellulase, a peroxidase, a protease, a gluco-amylase, an amylase, a lipase, a cutinase, a pectinase, a xylanase, a reductase, an oxidase, a phenoloxidase, a lipoxygenase, a ligninase, a pullulanase, a tannase, a pentosanase, a malanase, a β-glucanase, an arabinosidase and a mixture thereof. A preferred combination is a detergent composition having a cocktail of conventional applicable enzymes such as protease, amylase, lipase, cutinase and/or cellulase. An enzyme is typically present at from about 0.0001% to about 5% of active enzyme, by weight. Preferred proteolytic enzymes are selected from the group consisting of ALCALASE® (Novo Industri A/S), BPN′, Protease A and Protease B (Genencor), and mixtures thereof. Protease B is more preferred. Preferred amylase enzymes include TERMAMYL®, DURAMYL® and the amylase enzymes described in WO 9418314 to Genencor International and WO 9402597 to Novo. Further non-limiting examples of suitable and preferred enzymes are disclosed in WO 99/63034 to Vinson, et al., published on Dec. 9, 1999.

In preferred embodiments, antioxidants and free radical inhibitors, such as BHT (2,6-Di-t-butyl-4-methylphenol), and others known in the art, are included to limit oxidation of active ingredients. Other adjunct ingredients useful in the PME herein include an alkalinity source, a perfume, a dye, a reducing or oxidizing bleach, an odor-control agent such as cyclodextrin, and a mixture thereof. Other ingredients, such as dyes, perfumes, etc., known in the art of detergents, and especially dishwashing detergents may also be included herein as long as they do not affect the microemulsion structure or performance in any way.

The compositions herein may be formed by methods known in the art, such as simple stirring and mixing in a standard tank or mixer. Alternatively, dry or relatively low moisture ingredients may be mixed to form the PME herein.

Without intending to be limited by theory, it is believed that when the PME herein is diluted to form a ME, the ME includes a high-capacity oil absorption phase or a low-capacity oil absorption phase, depending upon the percent dilution. It is believed that the high-capacity oil absorption phase is likely characterized by a sponge-like or bicontinuous phase, whereas the low-capacity oil absorption phase is likely characterized by the formation of discrete micelles or particles. The high-capacity oil absorption phase is found at a product dilution of from about 50% to about 85%, preferably from about 60% to about 80%, and typically peaks around 70%, whereas the low-capacity oil absorption phase is found at higher dilution ratios (i.e., higher % water) than the high-capacity phase. These phases may be distinguished by methods known in the art.

Furthermore, when a dilution and oil-dissolution analysis is performed, the experimental results may be illustrated as shown in FIG. 1, which indicates both the high-capacity and low-capacity regions of a typical ME and the PME herein. In addition, it has been found that the high-capacity oil absorption phase has a high-capacity oil absorption value, which is the % oil-dissolution of the high-capacity oil absorption phase. Similarly, the low-capacity oil absorption phase has a low-capacity oil absorption value. By correlating these oil absorption values with the dilution of the composition, a curve may be obtained, which, for the present invention, typically follows the Gaussian function: f=3.9*exp{−0.5*[(x−54.7)/9.5]²}, where f=% Oil dissolved, and x=product concentration in %. It is further believed that the high-capacity and low-capacity oil absorption functions possess bell-shaped, symmetric curves, whereas traditional MEs possess non-Gaussian, skewed, asymmetric curves. Accordingly, the compositions herein are believed to be more easily predictable both in terms of effectiveness as well as physical parameters, as compared to previous compositions.

In FIG. 1, the dilution curves of a typical ME and a PME are described. In FIG. 1, the % oil-dissolution is measured by the test method below. Thus, when 10 mL of water is added to 90 mL of product, this corresponds to a dilution of 10% and a product concentration of 90%.

[image]

Therefore, the ME formed herein preferably has a ratio of high-capacity area to low-capacity area of from about 50:50 to about 99:1, more preferably from about 60:40 to about 97:3, and even more preferably from about 75:25 to about 95:5.

Method of Use

The composition herein is particularly suited for use as a cleaning composition, more preferably as a dishwashing composition, and even more preferably as a hand dishwashing composition. The invention herein is especially useful in the direct-application context where the PME is applied to a substrate such as a sponge, a wiping substrate, a scrubbing substrate, a nonwovern material, etc. Water is usually then added to the substrate to dilute the PME to form a ME in situ, preferably in or on the substrate itself, although the ME may also be formed in, for example, a sink or wash basin. The ME is then applied directly or indirectly to a surface to be cleaned, such as a dish, a glass, flatware, etc., and preferably soaked for from about 2 seconds to about 1 hour. The surface is rinsed to remove the dirt, soil, and ME and then preferably, dried. Such a method effectively cleans not only dishes, glasses, and flatware, but may also clean kitchen countertops, tile, bathrooms, hardwood floors, and other hard surfaces.

In addition, other methods of use are also useful, such as forming a ME by diluting the PME in, for example, a sink or wash basin, contacting the surface to be cleaned with the ME, preferably soaked for from about 2 seconds to about 1 hour, and then rinsed to remove the dirt, soil, and ME.

The physical form of the PME herein is typically a liquid, gel, paste, or even a solid and may itself be aqueous or non-aqueous. Other forms are also useful herein, as long as the PME may be diluted with water to form the desired ME. Furthermore, the PME herein may be provided as a separate product, or in conjunction with an applicator, for example, a dispensing container, a cleaning implement, and/or a wiping or scrubbing substrate. Preferred dispensing containers are known in the art, and will typically comprise a hand-held bottle having an aesthetically desirable and/or ergonomic shape, and a dispensing spout, trigger sprayer, or spray nozzle.

The wiping and/or scrubbing substrate useful herein is any type of substrate useful for delivering the PME, or the ME formed thereby, to a surface to be cleaned. The PME may be, for example, impregnated into the inner layers of the substrate, and/or be otherwise provided on the outer layers of the substrate. Examples of the substrate useful herein are a natural or artificial sponge, a woven substrate, a nonwovern substrate, a foam and a combination thereof. Particularly preferred examples of the substrate useful herein include those described in U.S. Pat. No. 4,515,703 to Haq, granted on May 7, 1985; EP-A2-0 161 911 to Rowe, et al., published on Nov. 21, 1985; EP-A-0 211 664 to Peter and Symien published on Feb. 25, 1987; EP-A2-0 353 014 to Edwards, et al., published on Jan. 31, 1990; and U.S. Patent Application No. 60/332,928 to Borgonjon, et al., filed on Nov. 16, 2001.

Test Methods:

The viscosity herein is measured on a Brookfield viscometer model # LVDVII₊ at 20° C. The spindle used for these measurements is a S31 spindle with the appropriate speed to measure products of different viscosities; e.g., 12 rpm to measure products of viscosity greater than 1 Pa*s; 30 rpm to measure products with viscosities between 0.5 Pa*s-1 Pa*s; 60 rpm to measure products with viscosities less than 0.5 Pa*s. If in a liquid, gel, or paste form, the invention herein typically has a viscosity of at least about 0.01 Pa*s, preferably from about 0.02 Pa*s to about 10 Pa*s, and more preferably from about 0.03 Pa*s to about 5 Pa*s.

The oil solubilization herein is measured both for the speed of absorption as well as the solubilization capacity. To measure the solubilization capacity, 10.0 g of product (this amount includes water, if testing at a specific dilution) to be tested is placed in a 25 mL scintillation vial. To this, 0.1 g food grade canola oil dyed with 0.045% of Pylakrome RED-LX1903 (a mixture of SOLVENT RED 24 CAS# 85-83-6 and SOLVENT RED 26 CAS# 4477-79-6, available from Pylam Products, Tempe, Ariz., U.S.A.) dye is added, and the vial capped. The vial is shaken vigorously by hand for 5 seconds, and allowed to stand until it becomes clear via the ISO 7027 turbidity measuring procedure, or until 5 minutes has passed, whichever comes first. The ISO 7027 method measures turbidity at a wavelength of 880 nm with turbidity measuring equipment such as that available from, for example, Omega Engineering, Inc., Stamford, Conn., U.S.A. If the vial becomes clear, then more oil is added, in increments of 0.1 g, until the vial fails to become clear within the prescribed time. The % oil dissolution is recorded as the maximum amount of oil which was successfully solubilized (i.e., the vial is clear) by 10.0 g of product. Without intending to be limited by theory, it is believed that the ionic surfactant-based PMEs and MEs herein solubilize significantly more oil than the nonionic MEs previously described in the art. Preferably, the invention herein solubilizes at least about 1 g of dyed canola oil, more preferably at least about 3 g of dyed canola oil, and even more preferably at least about 5 g of dyed canola oil when tested at a 75% product concentration.

To measure the speed of absorption, the above test is conducted, except that for a given 10.0 g of product, the time required (as measured at rest) for 0.1 g (i.e., 1%) of dyed canola oil to be solubilized is recorded. It is also believed that the ionic surfactant-based PMEs and MEs herein solubilize oil significantly faster than the nonionic MEs previously described in the art. Preferably the invention herein solubilizes 2% of dyed canola oil within about 15 minutes, more preferably within about 5 minutes, and even more preferably within about 60 seconds, when tested at a 75% product concentration.

The sudsing profile can be measured by employing a suds cylinder tester (SCT), having a set of 4 cylinders. Each cylinder is typically 30 cm long, and 10 cm in diameter. The cylinder walls are 0.5 cm thick, and the cylinder bottom is 1 cm thick. The SCT rotates a test solution in a closed cylinder, typically a plurality of clear plastic cylinders, at a rate of about 21 revolutions per minute, for 2 minutes, after which the suds height is measured. Soil may then be added to the test solution, agitated again, and the resulting suds height measured, again. Such a test may be used to simulate the initial sudsing profile of a composition, as well as its sudsing profile during use, as more soils are introduced from the surface being washed.

The sudsing profile test is as follows:

1. Prepare a set of clean, dry, calibrated cylinders, and water having a water hardness of 136.8 parts per million (2.1 grains per liter), and having a temperature of 25° C.

3. Add the appropriate amount of test composition to each cylinder and add water to make a total 500 mL of composition+water in each cylinder.

4. Seal the cylinders and place them in the SCT.

5. Turn on the SCT and rotate the cylinders for 2 minutes.

6. Within 1 minute, measure the height of the suds in centimeters.

7. The sudsing profile is the average level of suds, in cm, generated by the composition.

The compositions according to the invention preferably have a sudsing profile of at least about 2 cm, more preferably at least about 4 cm, and even more preferably about 5 cm.

### EXAMPLE 1

Non-limiting examples of compositions according to the invention are provided below:

| | A | | | | | F | | |
|---|---|---|---|---|---|---|---|---|
| | Compar. | B | C | D | E | Gel | G | H |
| Sodium C₁₂ Alkyl Ethoxy_{0.6} Sulfate | 35 | 40 | 35 | 35 | 28 | 30 | 28 | 28 |
| C₁₂₋₁₄ Alkyl Dimethyl Amine Oxide | 8.5 | 9.6 | 8.5 | 8.5 | 6.3 | 7.3 | 6.4 | 6.4 |
| C₈ Alcohol Ethoxylated Nonionic surfactant | 3.9 | 4.4 | 3.9 | 3.9 | 3 | 3.4 | 3 | 3 |
| Poly(dimethylaminomethacrylate) | 0.2 | 0.3 | 0.2 | 0.2 | 0.2 | 0.2 | 0.2 | 0.2 |
| 1,3-bis (methylamine)-cyclohexane | 0.6 | 0.7 | 0.6 | 0.6 | 0.5 | 0.6 | 0.5 | 0.5 |
| Enzyme (amylase/protease) | 0.1 | — | — | 0.1 | 0.1 | — | — | — |
| Limonene | 10 | — | — | — | — | — | — | — |
| Low Water-Soluble Compound | | | | | | | | |
| Phenyl ethylene glycol ether | — | — | 2.5 | 5 | 5 | 5 | 10 | — |
| Phenyl propylene glycol ether | — | 5 | 2.5 | | | — | — | 10 |
| Solvent | | | | | | | | |
| Ethanol | 10 | 6 | 2 | 10 | 12 | — | 3.6 | 3.6 |
| Propylene Glycol | — | — | 14 | — | — | — | 17 | 17 |
| tripropyleneglycol n-propyl ether | — | — | — | — | — | 10 | — | — |
| Monoethanolamide | — | — | — | — | — | 5 | — | — |
| Propylene Carbonate | — | — | — | — | 8 | — | — | — |
| Water | bal. | bal. | bal. | bal. | bal. | bal. | bal. | bal. |
| Thickeners | | | | | | | | |
| Fumed Silica | — | — | — | — | — | 2.5 | — | — |
| Xanthan gum | — | — | — | — | — | 2.5 | — | |
| Ratio of HC:LC¹ | 80:20 | 80:20 | 80:20 | 80:20 | 90:10 | — | 80:20 | 80:20 |
| Oil absorption capacity | 2% | 2% | 2% | 2% | 2% | — | 2% | 2% |
| Oil absorption speed | 60 sec. | 10 sec. | 10 sec. | 10 sec. | 10 sec. | — | 10 sec. | 10 sec. |

¹HC:LC indicates the ratio of high-capacity area to the low-capacity area.

The above examples possess acceptable sudsing profiles and rinsing profiles. Comparative Formula 1 is a commercially-available hand dishwashing composition. When compared to the Formulas A through E, Comparative Formula 1 is significantly less clear when absorbing oil. When measured with 2% dyed canola oil after 5 minutes, the turbidity of Comparative Formula 1 is 1237 NTU, whereas Formulas A through E are between 2 NTU, and 3 NTU, respectively.

### EXAMPLE 2

Compositions according to Formula A-E in Example I are produced, and oil absorption tests are conducted. Formula A containing limonene as the water-insoluble oil dissolves a maximum of 2% dyed canola oil after 1 minute (60 seconds). In contrast, Formulas B through E and E containing phenyl propylene glycol ether, phenyl ethylene glycol ether and combinations of the two as the low water-soluble solvent dissolve the same maximum of 2% dyed canola oil in 10 seconds.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An ionic surfactant-based protomicroemulsion comprising, by weight of the protomicroemulsion:
A. at least about 20% of an ionic surfactant system;
B. from about 0.1% to about 50% of a low water-soluble compound; and
C. from about 1% to about 40% of a solvent, wherein the protomicroemulsion forms a microemulsion when diluted from about 10% to about 99% with water, and wherein the protomicroemulsion is substantially free of a water-insoluble oil.

2. The protomicroemulsion composition according to claim 1, wherein the low water soluble compound is a phenyl glycol ether.

3. The protomicroemulsion composition according to claim 1, comprising a high capacity phase and a low capacity phase, wherein the high capacity phase dominates at a dilution of from about 10% to about 55% with water and wherein the low capacity phase dominates at a dilution of from about 50% to about 95% with water.

4. A cleaning implement comprising:
A. an ionic surfactant-based protomicroemulsion composition according to claim 1; and
B. a substrate impregnated with the protomicroemulsion composition.

5. The cleaning implement according to claim 4, wherein the substrate comprises a nonwoven fibrous material.

6. The cleaning implement according to claim 4, wherein the ionic surfactant-based protomicroemulsion composition further comprises a water transfer agent capable of withdrawing water from the surfactant.

7. A method for cleaning a surface comprising the steps of:
A. applying the protomicroemulsion composition according to claim 1 to a substrate;
B. adding water to the substrate to dilute the protomicroemulsion and form a microemulsion in situ;
C. applying the microemulsion to the surface via the substrate; and
D. rinsing the microemulsion from the surface to clean the surface.

8. A method for cleaning a surface comprising the steps of:
A. forming a microemulsion in situ by diluting a protomicroemulsion according to claim 1 with water;
B. contacting the surface with the microemulsion; and
C. rinsing the microemulsion from the surface to clean the surface.

9. An ionic surfactant-based microemulsion comprising, by weight of the microemulsion:
A. at least about 20% of an ionic surfactant system;
B. from about 0.1% to about 50% of a low water-soluble compound; and
C. from about 5% to about 79% of a solvent, wherein the microemulsion is substantially free of a water-insoluble oil.

10. A cleaning implement comprising:
A. an ionic surfactant-based microemulsion composition according to claim 9; and
B. a substrate impregnated with the microemulsion composition.
